(19) United States
(12) Patent Application Publication
(10) Pub. No.: US 2003/0138568 A1
(43) Pub. Date: Jul. 24, 2003

(54) Method of preparation and coating of heat-absorbing pigment

(76) Inventor: Kun Shang Huang, Taipei City (TW)

Correspondence Address: Kun Shang HUANG, PO Box 82-144, TAIPEI, TW

(21) Appl. No.: 10/051,110

(22) Filed: Jan. 22, 2002

(51) Int. Cl. B05D 1/02

(52) U.S. Cl. 427/421

(57) ABSTRACT

A method of preparation and coating of heat-absorbing pigment is disclosed. A heat-absorbing material is first dyed and undergone micro-capsulation process to form pigment to be added into a solvent forming as a coating material by spraying onto the surface of an article.

### BACKGROUND OF THE INVENTION

(a) Technical Field of the Invention

The present invention relates to pigment for surface coating on metallic or non-metallic article and pigment providing a heat-dissipation efficacy, and to a method of coating the pigment, and in particular, a method of preparation and coating of heat-absorbing pigment.

(b) Description of the Prior Art

Generally, computer components, electronic products and mechanical parts will generate heat energy in the operation process. For, heat dissipation fins and heat conduction tubes are normally mounted to these devices so as to expedite the dissipation of the generated heat energy. But, currently, the heat generated by these devices has increased gradually as a result of improvement in these devices. As a result of that, high efficiency heat dissipation device has to be developed in order to solve these problems.

Heat energy is generated in two forms, i.e., one which shown in the change of temperature, and the other being the latent heat, i.e., heat energy used in phase change. As for the computer components, electronic products or mechanical parts, copper and aluminum material are normally used as heat fins to dissipate heat energy.

In view of the above, in order to increase the anti-oxidation of the surface of the article and to provide color to the surface, paint or coating is used to furnish the surface. However, this coating will affect the heat dissipation efficiency of the fins. As a result, it is imperatively to provide a pigment which can furnish the surface of an article with color but will also dissipate heat.

### SUMMARY OF THE INVENTION

Accordingly, it is an object of the present invention to provide a method of preparation and coating of heat-absorbing pigment, wherein a micro-capsulated dyed-heat absorbing material as pigment is added into a solvent and is coated onto the surface of a heat dissipation article and is used as coating for furnishing onto the surface of the article.

Yet another object of the present invention is to provide a method of preparation and coating of heat-absorbing pigment, wherein the pigment is a strong coverage heat conduction medium which not only enhance the aesthetic appearance of the article but also improved heat dissipation efficacy of the article.

The foregoing object and summary provide only a brief introduction to the present invention. To filly appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the method of preparation in accordance with the present invention.

FIG. 2 shows a distribution of measuring points of an under test aluminum plate in accordance with the present invention.

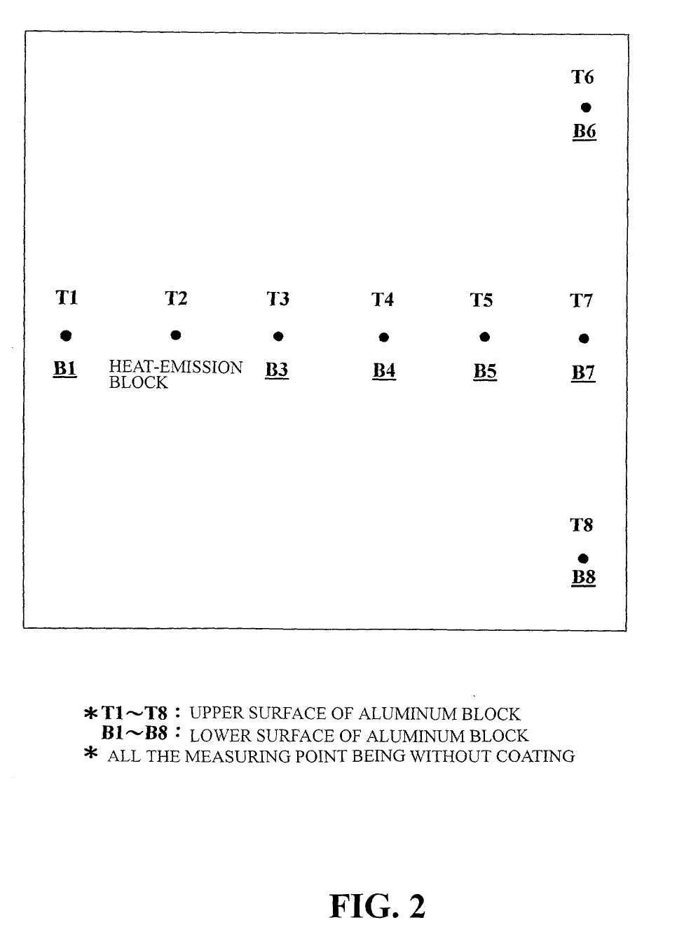

FIG. 3 shows the result of test for an experimental aluminum plate and a reference aluminum plate in accordance with the present invention.

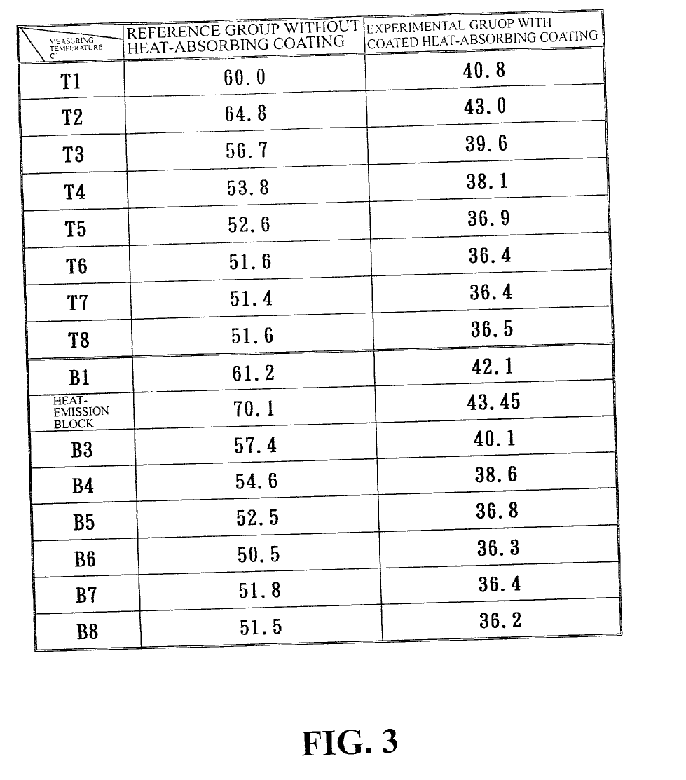

FIG. 4 shows a surface temperature change for an experimental aluminum plate and a reference aluminum plate at an output power of 10.8 Win accordance with the present invention.

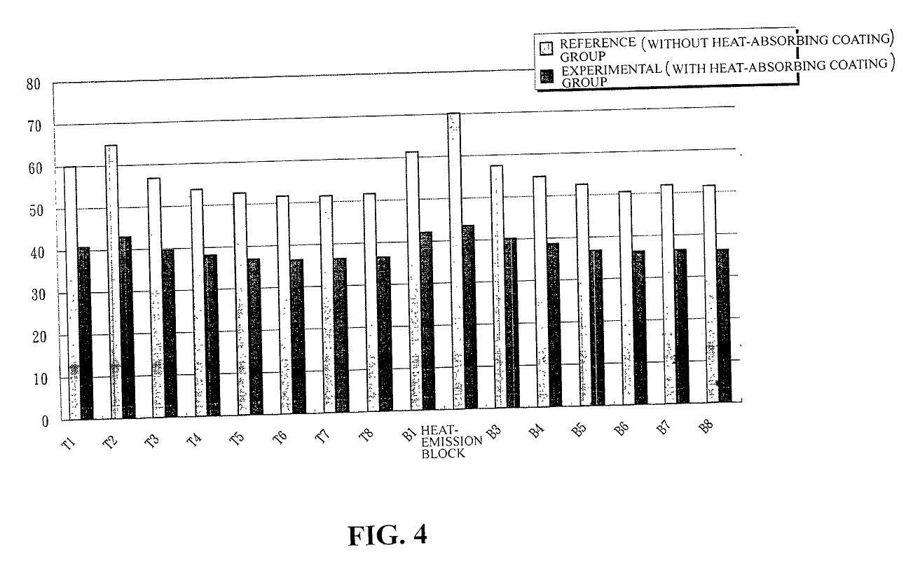

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

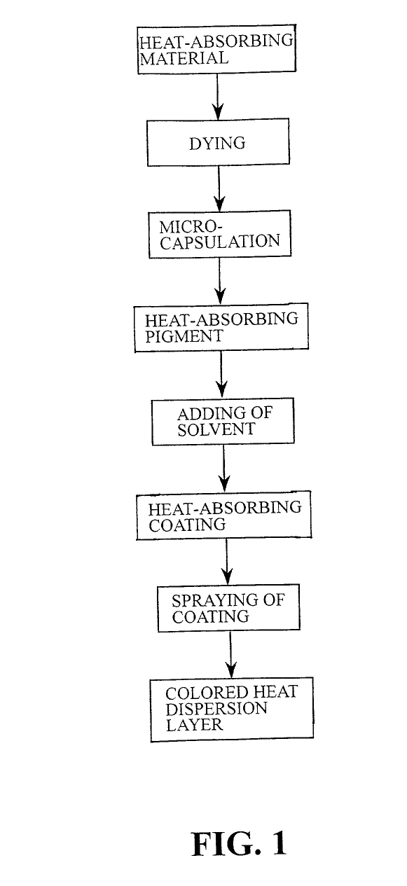

Referring to FIG. 1, there is shown a method of preparation and coating of heat-absorbing pigment.

An easily stored and dispersed heat heat-absorbing material is first dyed and then undergone micro-capsulation process to form micro granular pigment to be added with a solvent to form a coating material.

In accordance with the present invention, the heat-absorbing material is a phase-change material which can absorb heat energy as the energy for phase change. This material is a latent heat storage material and includes straight chain alkanes, alcohols, organic acids, and in particular, eicosane, pentadecanol, hexadecanol, hexadecanoic. When the heat-absorbing material absorbs heat energy, temperature lags for a period of time at the melting point of the phase-change material. Thus, when the heat-absorbing material is added to the heat dissipation article, the heat energy produced by the heat source will be rapidly absorbed by the heat-absorbing material and the heat will be rapidly dispersed to the air. Therefore, the heat energy that produced by the heat source will be effectively lowered.

As for the dyeing of the heat absorbing material, a dye with compatible properties is used so that the heat-absorbing material is formed into a specific color for further micro-capsulation process. The heat-absorbing material upon micro-capsulation has a granular size of several μm suitably used in solvent as additive for pigment.

The solvent is used as adhesive to assist pigment micro-capsule adhering onto the surface of the article. The solvent of the present invention includes epoxy resin, polyester resin, and epoxy-polyester resin is most preferred. An appropriate ratio of pigment micro-capsule and epoxy-polyester resin is used and after it has been dispersed at high temperature, it is used as a coating material and is coated by spraying onto the surface of the heat-dissipation article. Thus, a covering layer of a specific strength is obtained.

Referring to FIG. 1, there is shown the flowchart of the method of the present invention. In this preferred embodiment, the heat-absorbing material includes tetradecanol, and solvent includes epoxy-polyester resin. The method comprises the steps of preparing an appropriate amount of prepolymer aqueous solution of polytri-cyanamide aldehyde resin; preparing a mixture of a melted heat-absorbing material and a dye at a ratio of about 1000:3 until completely dissolved; adding the solution in about 5 volume of PVA aqueous solution and stirring the solution with an agitator at 6000 rpm to form emulsion; heating solution at 55° C. and stirring for about 1 hour; filtering and drying the obtained micro-capsule after the reaction is terminated; dissolving and dispersing 30 parts of micro-capsule with 70 parts of solvent and spraying onto the surface of a metallic or non-metallic article.

In accordance with the present invention, the surface of any object can be coated and the heat absorbing pigment can absorb heat. The heat absorbing pigment can also be sprayed on a larger surface area of the computer surface, for instance, the computer housing and a heat conduction wire or heat conduction plate is used to conduct heat energy from the heat source to the coated layer.

The effectiveness of the pigment can be seen from the following example, heat absorbing pigment is coated onto an aluminum plate of 10 mm×10 mm and a plurality of points thereof are tested. A 10.8W heating block is used and the environmental temperature is 30° C.

A comparative aluminum is used as a reference. The example shows that the surface with the pigment is lower than that without the pigment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of preparation and coating of heat-absorbing pigment comprising the steps of:
(a) preparing an appropriate amount of prepolymer aqueous solution of polytri-cyanamide aldehyde resin;
(b) preparing a mixture of a melted heat-absorbing material and a dye at a ratio of about 1000:3 until completely dissolved;
(c) adding the solution in (b) to about 5 volume of PVA aqueous solution and stirring the solution with an agitator at 6000 rpm to form emulsion;
(d) heating solution of (a) at 55° C. and stirring for about 1 hour;
(e) filtering and drying the obtained micro-capsule after the reaction is terminated; and
(f) dissolving and dispersing 30 parts of micro-capsule with 70 parts of solvent and spraying onto the surface of a metallic or non-metallic article.

2. The method of claim 2, wherein the heat-absorbing material includes straight-chain alkanes, alcohols, and organic acids.

3. The method of claim 3, wherein the straight-chain alkanes and alcohols include.

4. The method of claim 1, wherein the solvents include epoxy resin, polyester resin.

5. The method of claim I, wherein the heat-absorbing material is a non-dyed heat-absorbing pigment, and the heat-absorbing pigment is added to the solvent or a general pigment.

6. The method of claim 1, wherein the heat-absorbing pigment is coated onto the surface of an article.
